(19) United States
(12) Patent Application Publication
(10) Pub. No.: US 2023/0326144 A1
(43) Pub. Date: Oct. 12, 2023

(54) Triggering Field Transitions for Artificial Reality Objects

(71) Applicant: Meta Platforms Technologies, LLC, Menlo Park, CA (US)

(72) Inventor: Matthew Alan INSLEY, Seattle, WA (US)

(21) Appl. No.: 17/716,141

(22) Filed: Apr. 8, 2022

(51) Int. Cl. G06T 19/00; G06F 3/04815; G06F 3/01

(52) U.S. Cl. CPC G06T 19/006; G06F 3/04815; G06F 3/017

(57) ABSTRACT

Aspects of the present disclosure are directed to triggering object transitions between near-field and far-field regions in an artificial reality environment. For example, the near-field region can be within arm's length for the user, while the far-field region can be greater than arm's length from the user. Objects can be displayed within these regions such that the user can interact with the objects in the artificial reality environment. A field manager can cause a displayed object to transition from the near-field region to the far-field region and/or from the far-field region to the near-field region. The field manager can compare sensed user movements to one or more trigger criteria (e.g., distance threshold(s), velocity threshold(s), etc.) to trigger transition of an object between field regions.

### TECHNICAL FIELD

The present disclosure is directed to triggering object transitions between near-field and far-field regions in an artificial reality environment.

### BACKGROUND

Artificial reality devices provide opportunities for users to experience interactions in an artificial reality environment. However, user interactions with virtual objects in these environments have continued to present challenges. Touch based interactions often require virtual objects to be displayed near the user, however at times this can create a cluttered space near the user. For virtual objects displayed further from the user, the distance between the user and the virtual object can create its own set of interaction challenges.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIGS. 5A, 5B, and 5C are diagrams illustrating near-field and far-field object displays in artificial reality environment.

FIGS. 6A and 6B are diagrams illustrating field transitions for an object display in artificial reality environment.

FIG. 7 is a flow diagram illustrating a process used in some implementations of the present technology for triggering field transitions for an object in an artificial reality environment.

FIG. 8 is a flow diagram illustrating a process used in some implementations of the present technology for performing a field transition of an object in an artificial reality environment.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to triggering object transitions between near-field and far-field regions in an artificial reality environment. Implementations of an artificial reality system can project a user into an artificial reality environment that includes virtual objects. For example, the virtual objects can be two-dimensional panels, three-dimensional volumes, or any other suitable configuration. Within the artificial reality environment, the user can interact with a virtual object using different interaction mechanisms. In some implementations, the artificial reality environment can include regions relative to the user. A near-field region can be within arm's length for the user, while a far-field region can be greater than arm's length from the user. Objects can be displayed in these regions such that the user can interact with the objects in the artificial reality environment in different modalities (e.g., with rays for the far field and direct touch in the near field).

Implementations of a field manager can manage display of objects within the near-field region and far-field region. For example, the field manager can cause a displayed object to transition from the near-field region to the far-field region (or cause transition from the far-field region to the near-field region). In the near-field region, a user can interact with a displayed object using touch interactions, such as with the user's hands. For example, the user can engage the displayed object using an engagement gesture (e.g., pinch gesture), move the display location for the object in the near-field region, and otherwise interact with the object by touching elements of the object. In the far-field region, the user can interact with the displayed object using ray interactions. For example, a ray can extend from a user's body (e.g., from the user's hand or wrist) to target objects in the far-field region. The user can also engage with an object displayed in the far-field using an engagement gesture, however certain interactions may pose challenges.

For example, the ray-based interaction with an object display in the far-field can pose challenges for fine-grain selection. If an object displays text elements to a user, such as a news object, the user may find it difficult to use the ray interactions to select news articles, scroll through the articles, navigate different areas of the news interface displayed at the object, and the like. Moreover, the text displayed by the object may be difficult to read due to the distance between the far-field region and the user. Instead, the field manager can detect user movement that triggers a transition for the object from the far-field region to the near-field region. The benefits of object display in the near-field region can mitigate these challenges, such as a smaller distance between the object and the user and the availability of touch interactions with the object, which can achieve enhanced accuracy for fine-grain selection.

Implementations of the field manager compare sensed user movements to one or more trigger criteria to trigger transition of an object between field regions. For example, detection of an engagement gesture (e.g., pinch gesture) can initiate an engagement with a displayed object (in either the far-field or the near-field regions). When an object is engaged, user movements can move the location of the object within its current field region. While the object is engaged, the field manager can compare sensed user movement to trigger criteria, such as a distance threshold (e.g., radial distance from the user), a velocity threshold (e.g., overall velocity and/or change in velocity), any combination of these, or any other suitable trigger criteria. When the sensed user movement meets the trigger criteria, the field manager can trigger a transition between field regions (e.g., from near-field region to far-field region or from far-field region to near-field region).

In some implementations, while the object is engaged, user movements that do not meet the trigger criteria can move the object within its current field region, and user movement that meets the trigger criteria can cause transition between field regions. For example, the near-field region can be a free-form three-dimensional space, and a user can engage an object in the near-field and move with object anywhere within the free-form three-dimensional space (by way of user movements that do not meet the trigger criteria). To transition the object to the far-field region, for example to declutter the near-field region, the user can perform a movement that meets the trigger criteria while the object is engaged (e.g., movements that exceed a velocity threshold and/or exceed a radial distance threshold can trigger the transition). The field manager can sense the user movement and cause the object to transition to the far-field region. In this example, the user can manipulate the object in the near-field region using a variety of user movements (e.g., any movement that does not meet the trigger criteria), thus permitting the user to manage the near-field region with a high degree of customization. In other words, because field region transitions are limited to user movements that meet the trigger criteria, the user is free to perform other user movements to design and/or curate the display of objects within a given field region.

In some implementations, the far-field region has a radial distance from the user that is greater than 1 meter (e.g., 1.3 meters), meets a convergence criteria for an artificial reality system that implements the artificial reality environment, both of these, or can have any other suitable distance from the user. When an object is displayed in the far-field region, the user can engage the object and move the object, however the object's movements may be limited. For example, the object may be freely moved along a flat or curved two-dimensional surface defined around the user in the artificial reality environment (e.g., the radial distance of the object from the user may be fixed or may have a limited range of movement, such as 0.1 meters). In some implementations, objects displayed in the far-field region can be pinned to a predetermined radial distance for the far-field region.

When an object is transitioned, such as from the near-field region to the far-field region or from the far-field region to the near-field region, the field manager can dynamically alter the object dimensions, dynamically position the object within the new region, and maintain a display at the object. For example, the object can include at least a two-dimensional surface (e.g., a panel), and when transitioning from the near-field region to the far-field region the object can be scaled to a larger size. In some implementations, the field of view of the object relative to the user can be maintained. For example, at a distance closer to the user (e.g., the near-field region) the object may occupy a first portion of the user's field of view. When the object is transitioned to a distance further from the user (e.g., the far-field region) in order to occupy the first portion of the user's field of view the field manager can scale the object to a larger size. On the other hand, when transitioning from the far-field region to the near-field region the object can be scaled to a smaller size. In this example, when the object is transitioned to a distance closer to the user (e.g., the near-field region) in order to occupy the same portion of the user's field of view the field manager can scale the object to a smaller size.

The field manager can also dynamically position the object, such as when transitioning from the near-field region to the far-field region. For example, a ray cast from the user's body can intersect with the far-field region at an intersection point. The field manager can determine the display location for the engaged object according to the intersection point where the ray cast from the user's body meets the far-field region (e.g., at the time the field manager detects that the tracked movement meets the trigger criteria). The field manager can pin the object at the determined post-transition location.

In some implementations, the field manager can also dynamically position the object when transitioning from the far-field region to the near-field region. For example, a ray cast from the user's body that targets the object in the far-field region can intersect the near-field region. In some implementations, the intersection can be represented by a line through the three-dimensional space that defines the near-field region. The field manager can determine the display location for the engaged object based on the intersection line where the ray cast from the user's body passes through the near-field region, such as at a point on the intersection line. For example, the point on the intersection line can be a midpoint, a point on the line that is a predetermined radial distance from the user, or any other suitable point.

Implementations of the field manager can also maintain a display at the object during the transition. For example, the transition can include movement of the object from the pre-transition location to the post-transition location and, in some examples, a dynamic resizing of the object. Content at the object can continue during performance of this transition. For example, the field manager can continue playing a video at the object during the transition. In some implementations, the video can be dynamically resized according to the dynamic resizing of the entire object. In another example, the field manager can continue display of images and/or text during the transition, and these elements can also be dynamically resized according to the dynamic resizing of the entire object.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional virtual object interactions fail to provide experiences that meet user expectations, can cause congested spaces, and fail to support efficient interaction mechanisms for the user. For example, a conventional XR environment can display virtual objects near the user, however this can create congested space around the user. Another example conventional XR environment may permit the user to position virtual objects around the user in a free-form three-dimensional space. However, these XR environment can also become congested, and these systems fail to effectively utilize the space in the XR environment that is further than arm's length from the user.

Implementations of the disclosed technology are expected to overcome these deficiencies in conventional systems by providing a near-field region, a far-field region, and an efficient transition mechanism for transitioning virtual objects between these field regions. For example, the user can interact with virtual objects in the near-field region using touch-based interactions for fine control and interaction capability. Virtual objects can be transitioned to the far-field region to declutter the near-field region. Ray-based interactions permit user interaction with virtual objects in the far-field region, and the user can efficiently transition virtual objects from the far-field to the near-field for fine control and interaction. Implementations further improve over conventional systems through the comparisons of user movements to trigger criteria to trigger virtual object transitions between the near-field region and the far-field region. For example, a user can perform an engagement gesture to engage with a virtual object. Once engaged, the virtual object can be moved within its current field region according to user movements that do not meet the trigger criteria. When user movement that meets the trigger criteria is detected, the engaged virtual object can be transitioned to the new field region. According, the user is able to manipulate a virtual object in the near-field region using a variety of user movements (e.g., any movement that does not meet the trigger criteria), thus permitting the user to manage the near-field region with a high degree of customization. In other words, because field region transitions are limited to user movements that meet the trigger criteria, the user is free to perform other user movements to design and/or curate the display of objects within a given field region.

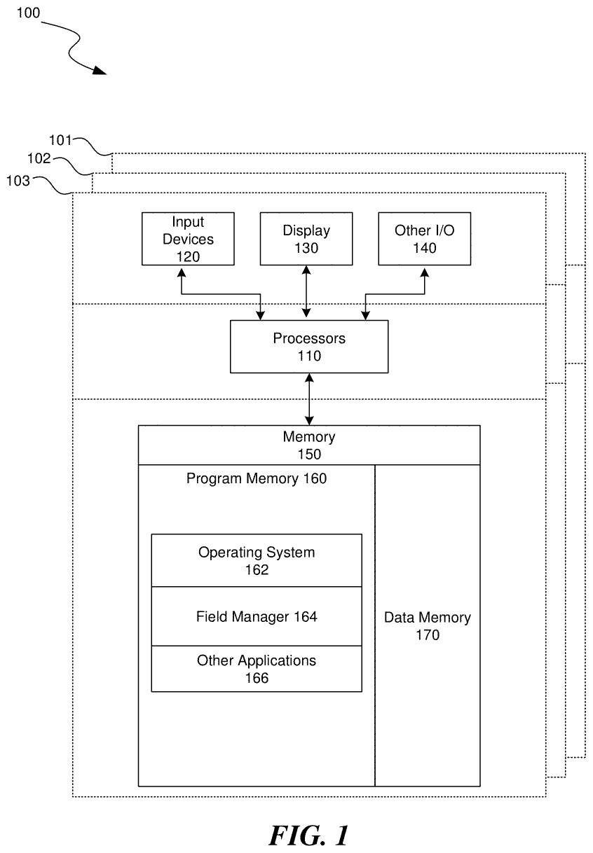

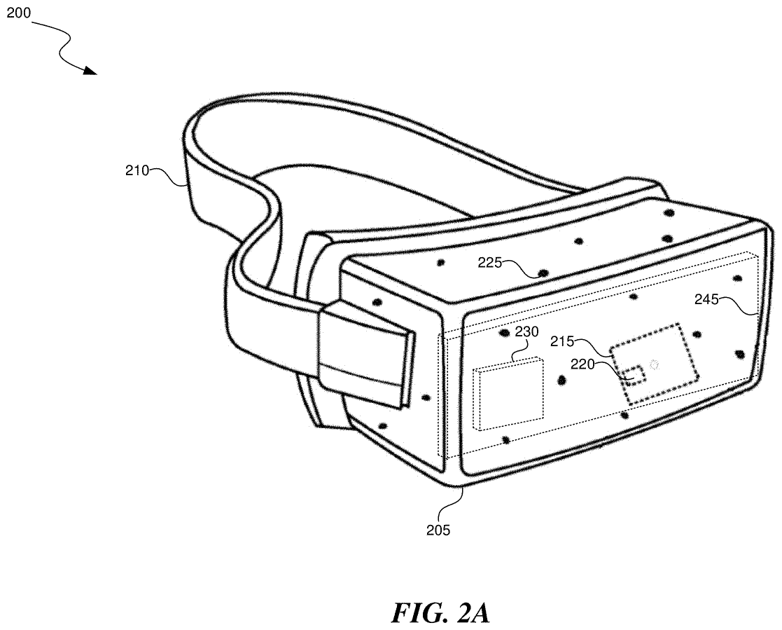

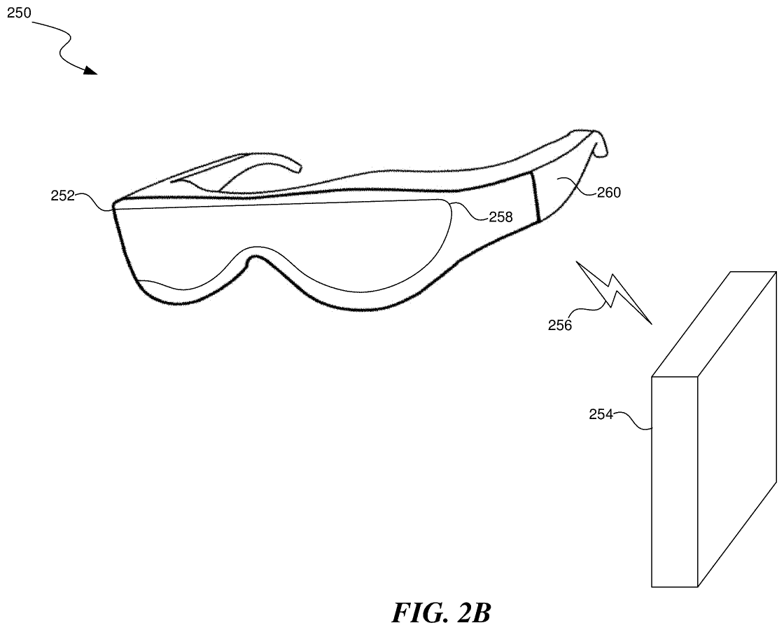

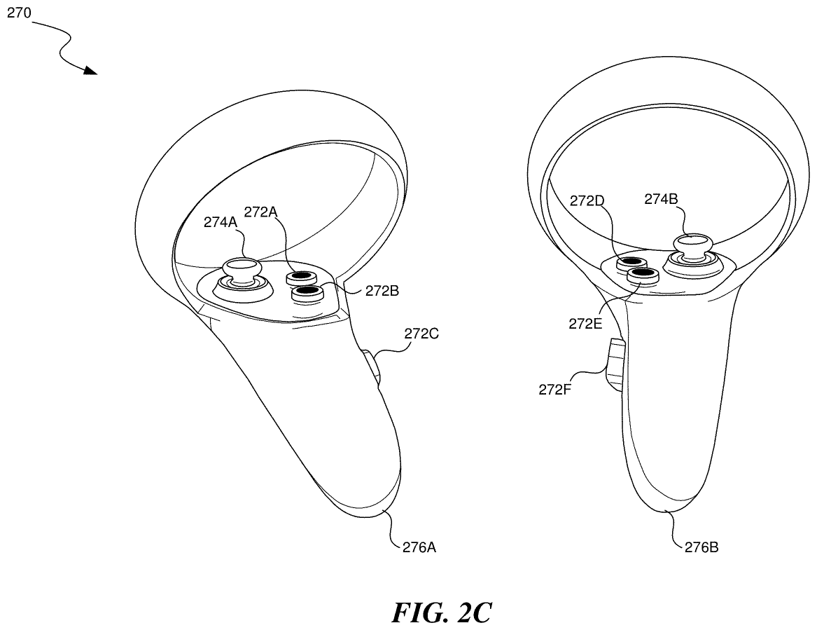

Several implementations are discussed below in more detail in reference to the figures. FIG. 1 is a block diagram illustrating an overview of devices on which some implementations of the disclosed technology can operate. The devices can comprise hardware components of a computing system 100 that trigger object transitions between near-field and far-field regions in an artificial reality environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, field manager 164, and other application programs 166. Memory 150 can also include data memory 170 that can include, e.g., object data, criteria data, region configuration data, social graph data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

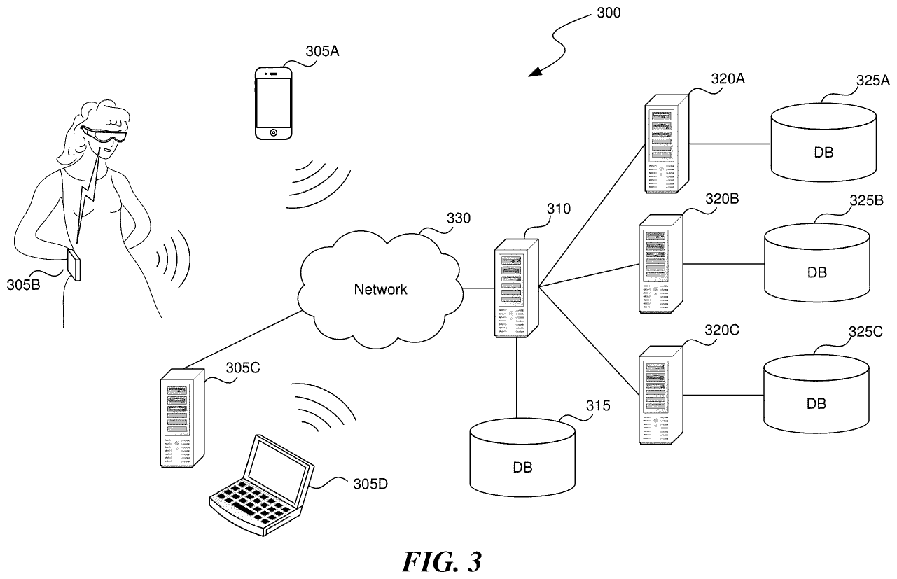

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

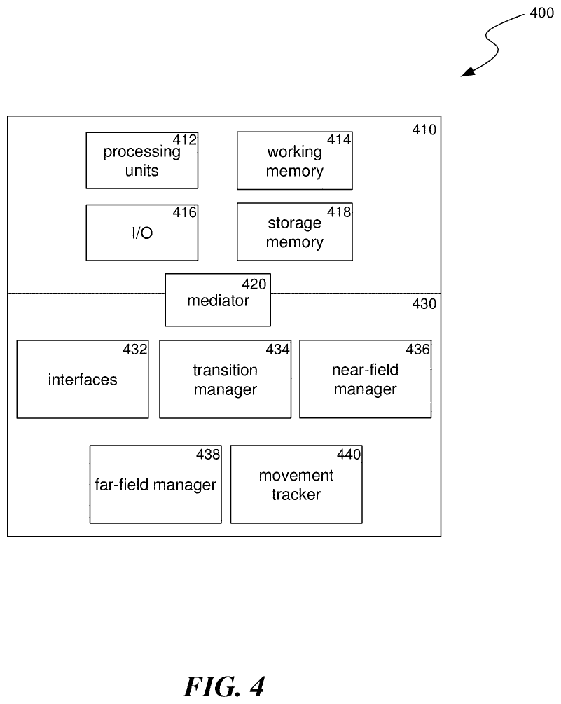

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for triggering object transitions between near-field and far-field regions in an artificial reality environment. Specialized components 430 can include transition manager 434, near-field manager 436, far-field manager 438, movement tracker 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

A near-field region can be a three-dimensional space near a user (e.g., within a threshold radial distance of the user) in the XR environment, such as within arm's length of the user. Near-field manager 436 can manage objects (e.g., two-dimensional panels, three-dimensional volumes, etc.) and user interactions in the near-field region. For example, the user (e.g., user projected in the XR environment) can engage objects in the near-field region, such as by targeting the objects with a hand movement (e.g., touch interaction) and performing an engagement gesture (e.g., pinch gesture). Near-field manager 436 can initiate and maintain an engagement between the user and the engaged object until the engagement gesture is released by the user.

Near-field manager 436 can dynamically move the display of the object according to user movements while the user is engaged with object. The near-field region can be a three-dimensional free-form space, and the user can dynamically move the engaged object anywhere within the three-dimensional free-form space according to the user's hand movements. When the user releases the engagement gesture, near-field manager 436 can position the object (e.g., lock or pin the object) at the location in the three-dimensional free-form space. The user can interact with objects in the near-field region using touch interactions, such as interactions to scroll content displayed by the objects, actuate buttons that perform functions (e.g., play a video, cause an application specific function), select a displayed element at the object, and other suitable interactions.

In some implementations, a far-field region can be at a distance greater than arm's length from the user in the XR environment, such as greater than 1 meter, 1.3 meters, at a convergence distance for the XR system that implements the XR environment, any combination thereof, or at any other suitable distance. Far-field manager 438 can manage objects and user interactions in the far-field region. For example, the user can engage objects in the far-field region, such as by targeting the objects with a hand movement (e.g., ray interaction) and performing an engagement gesture (e.g., pinch gesture). Far-field manager 438 can initiate and maintain an engagement between the user and the engaged object until the engagement gesture is released by the user.

Far-field manager 438 can dynamically move the display of the object according to user movements while the user is engaged with object. The far-field region can be a two-dimensional space at a fixed radial distance from the user or a two-dimensional space with a limited third dimension (e.g., 0.1 meters, etc.). The user can dynamically move the engaged object in the two-dimensions at the fixed radial distance or move the engaged object in the two dimensions and the limited third dimension. When the user releases the engagement gesture, far-field manager 438 can position the object (e.g., lock or pin the object) at the location in the two-dimensional space (or limited three-dimensional space). The user can interact with objects in the far-field region using ray interactions, such as interactions to target the object, select a displayed element at the object, and other suitable interactions. In some implementations, the ray-based interactions available for objects at the far-field region can be similar to the touch-based interactions available for objects in the near-field region, however the ray-based interaction may be less precise than the touch-based interaction.

A ray-based interaction can include a ray projection (i.e., straight line) from a control point along a casting direction. For example, the control point can be a palm, fingertips, a fist, a wrist, etc., and the casting direction can be along a line that passes through the control point and an origin point, such as a shoulder, eye, or hip. In other implementations, the control point can be based on other tracked body parts such as a user's eye, head, or chest. For example, the control point can be an estimated position of a center of a user's pupil and the origin point can be an estimated position of the center of a user's retina. In some cases, a graphical representation of the ray projection (the whole line or just a point where the ray hits an object) can be displayed in the artificial reality environment, while in other cases the ray projection is tracked by the XR system without displaying the ray projection. In various implementations, the ray projection can extend from the control point until it intersects with a first object or the ray projection can extend through multiple objects. In some implementations, the direction of the ray projection can be adjusted to “snap” to objects that it is close to intersecting or the ray projection can be curved up to a threshold amount to maintain intersection with such objects.

Transition manager 434 can manage transitions between a near-field region and a far-field region within a XR environment. In some implementations, while an object is engaged by the user (e.g., after the user has targeted an object, performed an engagement gesture, and maintained the engagement gesture), transition manager 434 can compare tracked movement by the user (e.g., hand movement tracked by movement tracker 440) to a trigger criteria. When the user movement meets the trigger criteria, the engaged object can be transitioned from its current field region to a new field region (e.g., from the near-field region to the far-field region or from the far-field region to the near-field region).

The trigger criteria can include one or more of: a) a threshold radial distance from the user; b) a velocity threshold; c) a change in velocity threshold; or d) any combination thereof. For example, when the tracked user movement meets the velocity threshold, transition manager 434 can perform a field region transition for the engaged object. In another example, when the tracked user movement exceeds the radial distance threshold (or falls below the radial distance threshold) transition manager 434 can perform a field region transition for the engaged object.

In an example, transition manager 434 can transition an engaged object in the near-field region to the far-field region. In this example, the object management for the engaged object can be transitioned from near-field manager 436 to far-field manager 438. Transition manager 434 can dynamically position the engaged object in the far-field region. For example, a ray cast from the user's body can intersect with the far-field region at an intersection point. The display location for the engaged object post-transition can be determined as the intersection point where the ray cast from the user's body meets the far-field region (e.g., at the time when transition manager 434 detects that the tracked movement meets the trigger criteria). When the user releases the gesture used to engage the object, transition manager 434 can pin the object to the far-field region at the determined post-transition location.

When the engaged object transitions from the near-field region to the far-field region, transition manager 434 can dynamically scale the engaged object to a larger size. In some implementations, transition manager 434 can maintain the field of view for the engaged object during the transition. For example, at a distance closer to the user (e.g., the near-field region) the engaged object may occupy a first portion of the user's field of view. When the engaged object is transitioned to a distance further from the user (e.g., the far-field region) in order to occupy the first portion of the user's field of view transition manager 434 can scale the engaged object display to a larger size.

In another example, transition manager 434 can transition an engaged object in the far-field region to the near-field region. In this example, the object management for the engaged object can be transitioned from far-field manager 438 to near-field manager 436. Transition manager 434 can dynamically position the engaged object in the near-field region. For example, a ray cast from the user's body that targets the engaged object in the far-field can intersect with the near-field region. In some implementations, the intersection can be represented by a line through the three-dimensional space that defines the near-field region. The display location for the engaged object post-transition can be determined as a point on the intersection line where the ray cast from the user's body passes through the near-field region. For example, the point on the intersection line can be a midpoint, a point on the line that is a predetermined radial distance from the user, or any other suitable point.

When the engaged object transitions from the far-field region to the near-field region, transition manager 434 can dynamically scale the engaged object to a smaller size. In some implementations, transition manager 434 can maintain the field of view for the engaged object during the transition. For example, at a distance further from the user (e.g., the far-field region) the engaged object may occupy a first portion of the user's field of view. When the engaged object is transitioned to a distance closer to the user (e.g., the near-field region), to occupy the first portion of the user's field of view, transition manager 434 can scale the engaged object display to a smaller size.

Implementations of transition manager 434 can also maintain a display at the engaged object during the transition. For example, the transition can include movement of the engaged object from the pre-transition location to the post-transition location. Content displayed by the engaged object can continue to be displayed while transition manager 434 transitions the object. For example, a video displayed by the engaged object can continue to play, the display of images and/or text can be maintained, and other suitable content can continue to be displayed. In some implementations, the video, images and/or text, and other suitable content can be dynamically resized during the transition, such as according to the dynamic resizing of the engaged object.

Movement tracker 440 can track real-world user movements sensed by an XR system. For example, an XR system can include one or more cameras, hand-held controllers, wearable devices, or any other suitable sensors. These sensors can sense real-world movements from the user. Movement tracker 440 can track the sensed real-world movements such that the user movements can be projected in the XR environment. For example, the user projected in the XR environment can interact with objects in the XR environment based on the sensed and tracked movements. Tracked user hand movements can include a distance traveled, velocity (e.g., speed and direction), and any other suitable tracking. In some implementations, transition manager 434 can compare the tracked movements (e.g., tracked user hand movements) to one or more trigger criteria to trigger field transitions for engaged objects in the XR environment.

Implementations can estimate an individual user's maximum hand/arm extension using any suitable technique. For example, an XR system can track the user's movements over time. The maximum extension (e.g., radial distance from the user) for the user's hand/arm can be tracked and updated over numerous XR environment interactions. Based on these tracked values, an arm's length maximum distance can be estimated for the user.

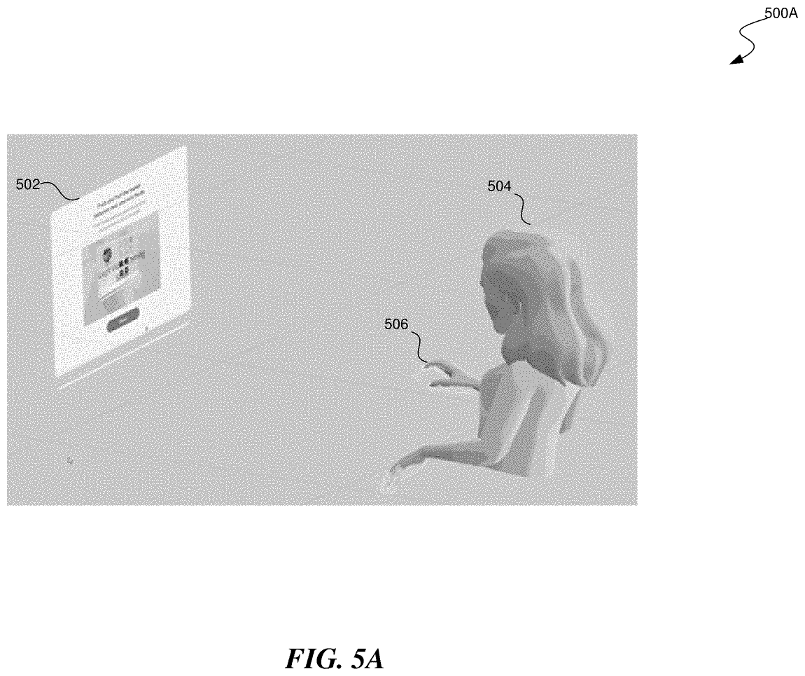

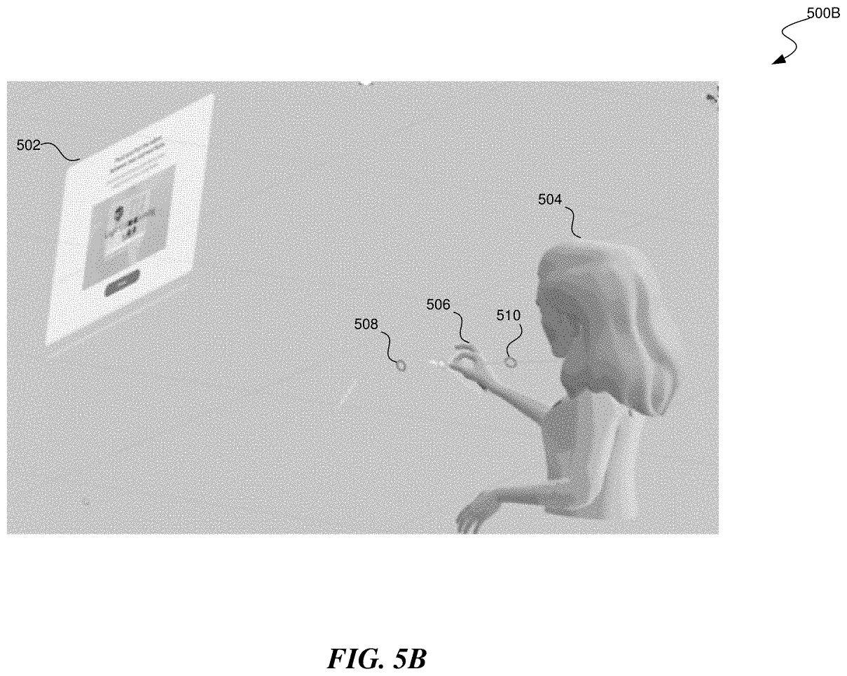

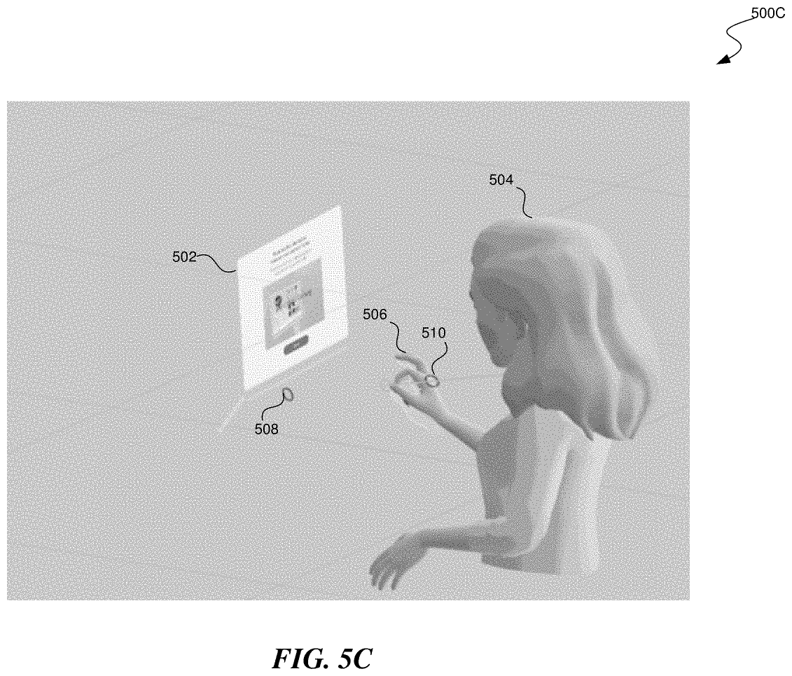

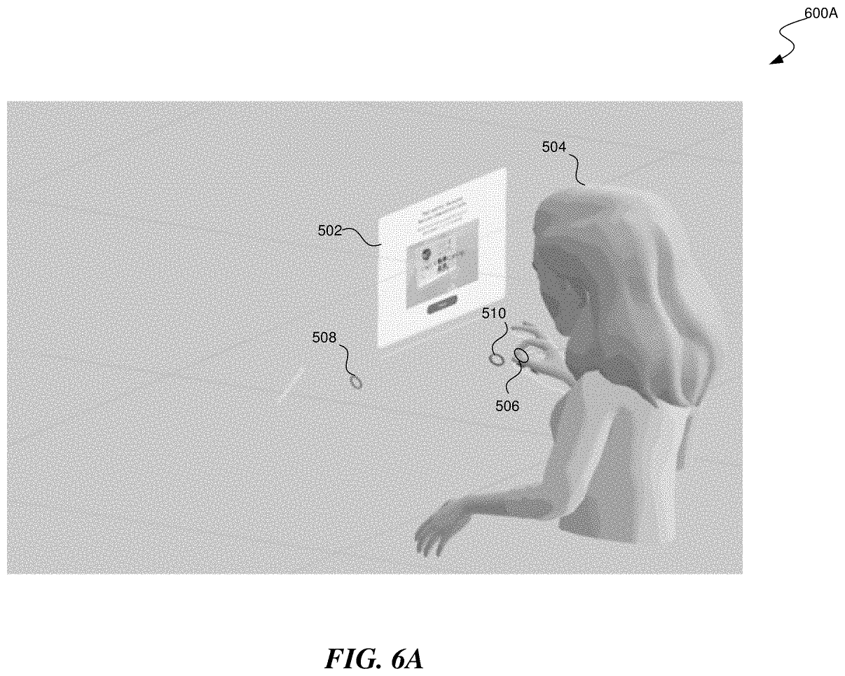

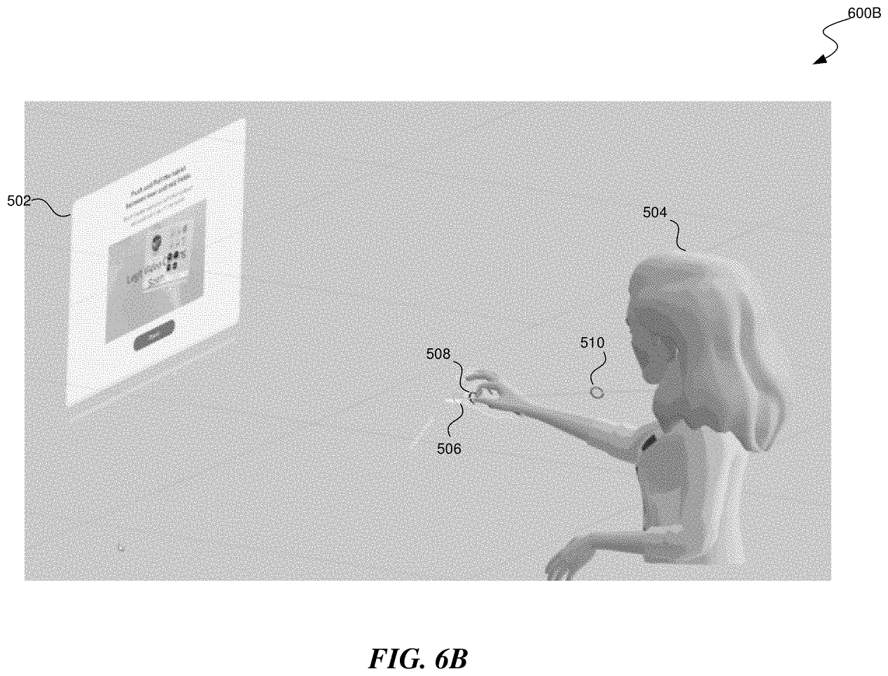

FIGS. 5A, 5B, and 5C are diagrams illustrating near-field and far-field object displays in artificial reality environment. Diagrams 500A includes objects 502, user 504, and user hand 506. Diagrams 500B and 500C include object 502, user 504, user hand 506, and thresholds 508 and 510. FIGS. 6A and 6B are diagrams illustrating field transitions for an object display in artificial reality environment. Diagrams 600A and 600B include object 502, user 504, user hand 506, and thresholds 508 and 510.

Diagrams 500A, 500B, 500C, 600A, and 600B show XR environments implemented by an XR system. The XR environments can include a near-field region and a far-field region. User 504 can be the projection of a user in the XR environment. User hand 506 in the XR environment can simulate user hand movements sensed in the real-world. Object 502 can be a virtual object, such as a two-dimensional object (e.g., a panel), a three-dimensional volume, or any other suitable virtual object.

In diagram 500A, object 502 is located in a far-field region of the illustrated XR environment. For example, user 504 can interact with object 504 at the far-field region according to ray-based interactions. In some implementations, a ray cast from user hand 506 can target object 502. In diagram 500B, user hand 506 has performed an engagement gesture (e.g., pinch gesture) to engage object 502 in the far-field region. For example, the ray cast from user hand 506 targeted object 502 and the engagement gesture engaged object 502. In diagram 500C, object 502 is located in a near-field region of the illustrated XR environment, and user hand 506 has performed an engagement gesture to engage object 502 in the near-field region. In this example, user 504 can interact with object 502 at the near-field region according to touch-based interactions.

Diagrams 500B and 500C also illustrate thresholds 508 and 510. Thresholds 508 and 510 can be example trigger criteria, such as radial distance thresholds from user 504. In some implementations, the radial distances can be measured from a predetermined location on user 504 (e.g., the shoulder, a point on the chest, or other suitable points). Threshold 508 can correspond to a radial distance for triggering a transition from the near-field region to the far-field region and threshold 510 can correspond to a radial distance for triggering a transition from the far-field region to the near-field region. For example, threshold 508 can be set to a radial distance at or near the user's arm length offset from a maximum extension and threshold 510 can be set to a radial distance offset from a maximum retraction. Thresholds 508 and 510 can be set to any other suitable distances and can represent a radial distance or any other suitable distance type.

Diagrams 500B and 600A illustrate an example transition for object 502 from the far-field region to the near-field region based on user hand 506 meeting threshold 510. For example, diagram 500B illustrates object 502 in a pre-transition location and diagram 600A illustrates object 502 in a post-transition location. Diagram 500B illustrates that object 502 is engaged. A transition can be triggered when tracked user hand movement (e.g., represented by movement of user hand 506) meets threshold 510. Diagram 600A illustrates that user hand 506 has moved past threshold 510. For example, threshold 510 can be a minimal radial distance threshold, and user hand 506 can move to a radial distance from user 504 that is less than or equal to threshold 510. Based on the tracked user had movement meeting threshold 510 (e.g., a trigger criteria), object 502 can be transitioned from the far-field region to the near-field region. Accordingly, diagram 600A illustrates object 502 in a post-transition location in the near-field region.

Diagrams 600A and 600B illustrate an example transition for object 502 from the near-field region to the far-field region based on user hand 506 meeting threshold 508. For example, diagram 600A illustrates object 502 in a pre-transition location and diagram 600B illustrates object 502 in a post-transition location. In some implementations, a user can first transition object 502 from the far-field region to the near-field region as illustrated by the sequence of diagrams 500B and 600A, and second transition object 502 from the near-field region to the far-filed region, as illustrated by the sequence of diagrams 600A and 600B.

Diagram 600A illustrates that object 502 is engaged. A transition can be triggered when tracked user hand movement (e.g., represented by movement from user hand 506) meets threshold 508. Diagram 600B illustrates that user hand 506 has moved past threshold 508. For example, threshold 508 can be a maximum radial distance threshold, and user hand 506 can move to a radial distance from user 504 that is greater than or equal to threshold 508. Based on the tracked user had movement meeting threshold 508 (e.g., a trigger criteria), object 502 can be transitioned from the near-field region to the far-field region. Accordingly, diagram 600B illustrates object 502 in a post-transition location in the far-field region.

In some implementations, thresholds 508 and 510 can be dynamic according to where user hand 506 performs the engagement gesture and establishes engagement with object 502. For example, if user hand 506 first engages object 502 near threshold 508 (e.g., corresponding to a radial distance at or near a maximum extension for the user), a transition can be unintentionally triggered by a slight movement of user hand 506. In some implementations, when user hand 506 engages object 502 within a proximity threshold of threshold 508, a delta distance (e.g., predetermined radial distance) can be added to threshold 508. In this example, threshold 508 may be extended past the original threshold to mitigate against unintentionally triggering transition of object 502. In some cases, when a user's hand passes a threshold distance, hysteresis can be applied to prevent the continual triggering of filed transitions as the user's hand is near a trigger distance. In some implementations, the delta distance can be temporarily added to threshold 508, and the threshold can return to the original radial distance threshold value after a period of time (e.g., 1 second, 2 seconds, 5 seconds, and the like).

In another example, if user hand 506 first engages object 502 near threshold 510 (e.g., corresponding to a radial distance at or near a maximum retraction for the user), a transition can be unintentionally triggered by a slight movement of user hand 506. In some implementations, when user hand 506 engages object 502 within a proximity threshold of threshold 510, a delta distance (e.g., predetermined radial distance) can be subtracted from threshold 510. In this example, threshold 510 may be moved back from the original threshold to mitigate against unintentionally triggering transition of object 502. In some implementations, the delta distance can be temporarily subtracted from threshold 510, and the threshold can return to the original radial distance threshold value after a period of time.

Those skilled in the art will appreciate that the components illustrated in FIGS. 1-4, 5A, 5B, 5C, 6A, and 6B described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

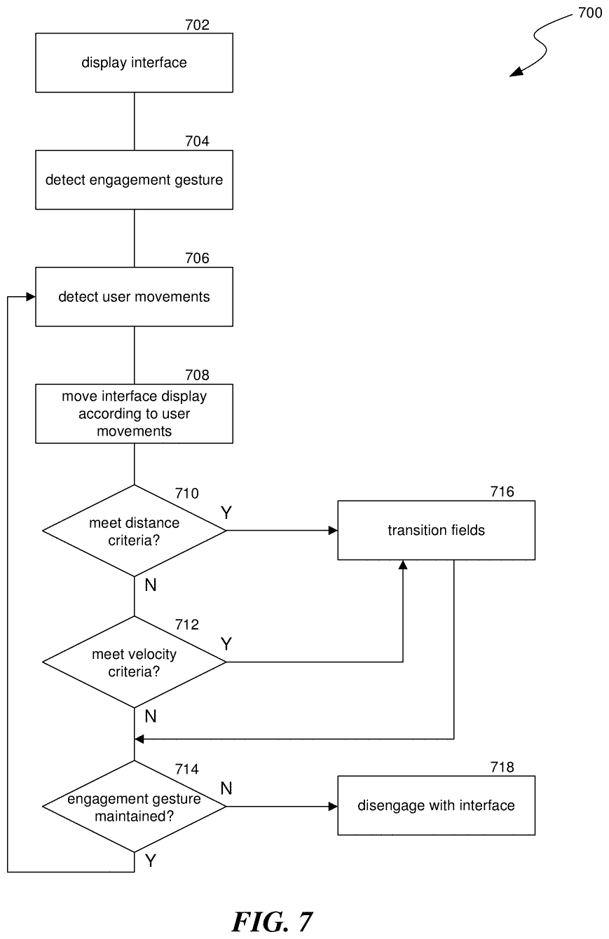

FIG. 7 is a flow diagram illustrating a process used in some implementations of the present technology for triggering field transitions for an object in an artificial reality environment. In some implementations, process 700 can be performed by an application or operating system of an XR system. Process 700 can occur while a user interacts with an XR environment.

At block 702, process 700 can display a virtual object to a user in an XR environment. For example, the virtual object can be a virtual object with a two-dimensional surface (e.g., a panel or interface), three-dimensional volume, or any other suitable virtual object. The user can be an XR representation of a user projected into a VR environment by an XR system or can view a live version of themselves in an MR or AR environment.

In some implementations, the XR environment can include a near-field region and a far-field region. For example, the near-field region can be a three-dimensional free-form space that is at a distance from the user within arm's length. In another example, the far-field region can be a two-dimensional space at a fixed distance from the user, or a two-dimensional space with a third dimension (distance the user) that has a limited span (e.g., 0.1 meters, and the like). The far-field region can have: a) a radial distance greater than 1 meter from the user; b) a radial distance from the user that meets a convergence criteria for the XR system that implements the XR environment; or c) any combination thereof. The virtual object can be located in the near-field region or the far-field region.

In some implementations, when displayed in the near-field region the user interacts with the virtual object in the XR environment using touch interactions, and when displayed in the far-field region the user interacts with the virtual object in the XR environment using ray projection interactions. For example, the user interacts with the virtual object using touch interactions by touching the object with a hand of the user in the XR environment. In another example, the user interacts with the virtual object using ray projection interactions using a ray that extends from the user's body in the XR environment.

At block 704, process 700 can detect an engagement gesture by the user. For example, the XR system can track user movements and detect an engagement gestured (e.g., pinch gesture, an air-tap gesture, a grab gesture, etc.) from the user. In some implementations, the engagement gesture can initiate engagement with the virtual object. For example, the user can target the virtual object, such as using a touch-based interaction and/or a ray-based interaction. While targeting the virtual object, the user can perform the engagement gesture to initiate engagement with the virtual object. In some implementations, the engagement between the user and the virtual object can be maintained until the user releases the engagement.

At block 706, process 700 can detect user movements. In some cases (e.g., for some VR embodiments), the XR system can translate real-world user movements (e.g., hand movements) into movements for the user projected in the XR environment.

At block 708, process 700 can move the virtual object according to the user movements. For example, the detected user movements can occur while engagement with the virtual object is maintained, and the virtual object can be moved according to the user movements. For example, user movements can dynamically move an engaged virtual object in the near-field anywhere within the three-dimensional free-form space defined for the near-field (e.g., according to the user's hand movements). In another example, user movements can dynamically move an engaged virtual object in the far-field in the two dimensions at the fixed distance of the far-field (or the two dimensions and the limited third dimension of the far-field).

At block 710, process 700 can determine whether the user movements meet a distance criteria. When a virtual object is located in the near-field region, the user movements can meet the distance criteria when a radial distance for the user's hand location (e.g., in the XR system relative to the user's body) meets or exceeds a radial distance threshold that corresponds to a maximum arm extension for the user (e.g., an estimate of the user's arm reach at full extension). When virtual object is located in the far-field region, the user movements can meet the distance criteria when a radial distance for the user's hand location (e.g., in the XR system relative to the user's body) meets or falls below a radial distance threshold that corresponds to a maximum arm retraction for the user. When the user movements meet the distance criteria, process 700 can progress to block 716. When the user movements do not meet the distance criteria, process 700 can progress to block 712.

At block 712, process 700 can determine whether the user movements meet a velocity criteria. For example, the velocity criteria can include a velocity threshold, change in velocity threshold, or any other suitable velocity or speed-based threshold. In some embodiments, when a determined velocity/speed for the user movements meets or exceed the velocity threshold(s), the velocity criteria can be met. When the user movements meet the velocity criteria, process 700 can progress to block 716. When the user movements do not meet the velocity criteria, process 700 can progress to block 714.

In some implementations, blocks 710 and 712 can be combined such that a field transition for an engaged virtual object is triggered by detected user movement when the distance criteria is met and the velocity criteria is met. For example, the field region transition can be triggered when detected user movement meets the distance criteria (e.g., meets or exceeds a first radial distance threshold, meets or falls below a second radial distance threshold, etc.), and meets the velocity criteria (e.g., meets or exceeds a velocity threshold and/or meets or exceeds a changed in velocity threshold).

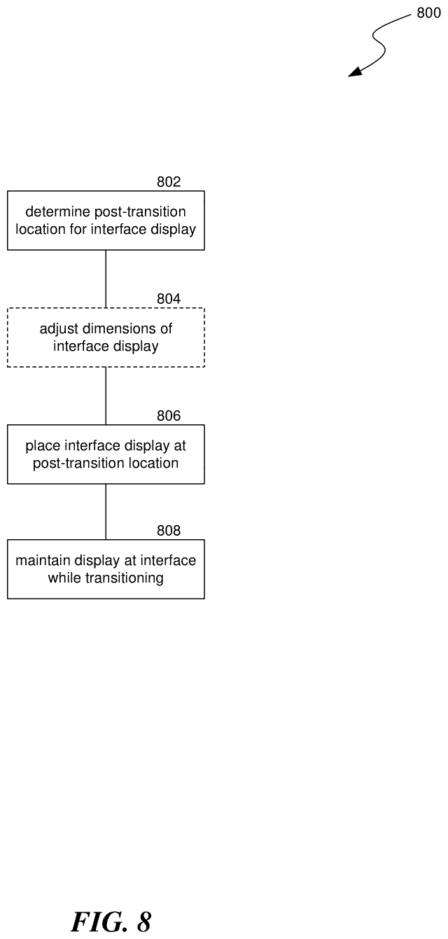

At block 716, process 700 can transition the field region for the engaged virtual object. For example, the engaged virtual object can be transitioned from the near-field region to the far-field region or from the far-field region to the near field region. Process 800 of FIG. 8 further describes performance of a field region transition.

At block 714, process 700 can determine whether the user has maintained the engagement gesture. For example, the engagement gesture (e.g., pinch gesture) can be maintained until a disengagement gesture (e.g., release of the pinch gesture) is detected. Implementations of the XR system sense real-world user hand movements to detect whether the user performs a disengagement gesture.

In some implementations, the engagement and/or disengagement gesture can be detected by a model configured to detect the gestures (e.g., a trained machine learning model). For example, the model can output as a confidence value (e.g., value between 1 and 100) that the user has performed the disengagement gesture (or that the user has performed or continues to perform the engagement gesture). In some implementations, the disengagement gesture can be detected when the confidence value meets a threshold confidence value (e.g., 60, 70, or any other suitable threshold).

In some implementations, the threshold confidence value can be dynamically increased in relation to a determined velocity/speed for detected user movement. For example, the higher the value of a determined velocity/speed for detected user movement, the higher the threshold confidence value (e.g., the larger the dynamic increase). The dynamic increase in the threshold confidence value can mitigate against the risk of unintended disengagement at high speeds for user movement. In particular, gesture predictions generated by some models may decrease in accuracy at higher speed user movements. Accordingly, some implementations can increase the threshold confidence value to counterbalance the reduced accuracy. In some implementations, the amount of change in a user's gesture to disengage the gesture can also be based on movement velocity. For example, if the engagement gesture is a pinch, the faster the user's hand is moving, the further apart the thumb and index finger tips have to be moved for the system to identify a disengagement of the gesture.

When the user has not maintained the engagement gesture, process 700 can progress to block 718. When the user has maintained the engagement gesture, process 700 can loop back to block 706, where additional user movements can be detected.

At block 718, process 700 can disengage with the virtual object. For example, the virtual object can be positioned at a location in the current field region in which the virtual object is located. The positioned location can correspond to the location for the virtual object at the time disengagement was detected. In some implementations, when disengagement occurs in the near-field region, the virtual object can be positioned (e.g., locked or pinned) at the location in the three-dimensional free-form space. In some implementations, when disengagement occurs in the far-field region, the virtual object can be positioned (e.g., locked or pinned) at the location in the two-dimensional space (e.g., at the fixed distance from the user).

FIG. 8 is a flow diagram illustrating a process used in some implementations of the present technology for performing a field transition of an object in an artificial reality environment. In some implementations, process 800 can be performed by an application or operating system of an XR system. Process 800 can occur while a user interacts with an XR environment. In some implementations, process 800 can reflect a transition process for virtual object, such as block 714 of FIG. 7.

At block 802, process 800 can determine a post-transition location can be for the virtual object. In an example where an engaged virtual object is transitioned from the near-field region to the far-field region, a ray cast from the user's body can intersect with the far-field region at an intersection point. At the time of detection that the user's movements meet the trigger criteria, the determined display location at the far-field region for the virtual object post-transition can be the intersection point where the ray cast from the user's body meets the far-field region.

In another example where an engaged virtual object is transitioned from the far-field region to the near-field region, a ray cast from the user's body that targets the virtual object in the far-field region can intersect the near-field region. In some implementations, the intersection can be represented by a line through the three-dimensional space that defines the near-field region. At the time of detection that the user's movements meet the trigger criteria, the determined display location at the near-field region for the virtual object post-transition can be at a point on the intersection line, such as a midpoint, a point on the line that is a predetermined radial distance from the user, or any other suitable point.

While any block can be removed or rearranged in various implementations, block 804 is shown in dashed lines to indicate there are specific instances where block 804 is skipped. At block 804, process 800 can adjust dimensions for the display of the virtual object according to the triggered transition. For example, when transitioning from the near-field region to the far-field region the virtual object can be scaled to a larger size. In some implementations, the field of view of the interface display relative to the user can be maintained. For example, at a distance closer to the user (e.g., the near-field region) the virtual object may occupy a first portion of the user's field of view. When the virtual object is transitioned to a distance further from the user (e.g., the far-field region) in order to occupy the first portion of the user's field of view the virtual object can be dynamically scaled to a larger size. On the other hand, when transitioning from the far-field region to the near-field region the virtual object can be scaled to a smaller size. In this example, when the virtual object is transitioned to a distance closer to the user (e.g., the near-field region) in order to occupy the same portion of the user's field of view the virtual object can be dynamically scaled to a smaller size.

At block 806, process 800 can position the display of the virtual object at the determined location for the triggered transition. For example, the virtual object can be pinned or locked to the determined post-transition location. Engagement with the virtual object (e.g., continued engagement or engagement via a new detected engagement gesture) and detected user movement can move the virtual object from the post-transition location.

At block 808, process 800 can maintain, during performance of the triggered transition, a dynamic display at the virtual object. For example, the transition can include movement of the virtual object from the pre-transition location to the post-transition location and, in some examples, a dynamic resizing of the virtual object. Content at the virtual object can continue during performance of this transition. For example, a video played at the virtual object can continue playing during the transition. In some implementations, the video can be dynamically resized according to the dynamic resizing of the entire virtual object. In another example, images and/or text can continue to be displayed during the transition, and these elements can also be dynamically resized according to the dynamic resizing of the entire virtual object.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for triggering object transitions between near-field and far-field regions in an artificial reality environment, the method comprising:
displaying, to a user within an artificial reality environment, a virtual object comprising at least a two-dimensional surface, wherein the virtual object is displayed in a near-field region that is within arm's length from the user;
detecting an engagement gesture, by the user, that engages the virtual object in the near-field region until a release of the engagement by the user;
detecting, after the virtual object is engaged, a hand movement by the user that meets a trigger criteria, wherein the trigger criteria comprises: a) a threshold radial distance from the user; b) a velocity threshold; c) a change in velocity threshold; or d) any combination thereof; and
transitioning, based on the detected hand movement that meets the trigger criteria, the virtual object from the near-field region to a far-field region, wherein the virtual object is displayed in the far-field region at a distance greater than arm's length from the user.

2. The method of claim 1, wherein, when displayed in the near-field region, the user interacts with the virtual object in the artificial reality environment using touch interactions, and when displayed in the far-field region the user interacts with the virtual object in the artificial reality environment using ray projection interactions.

3. The method of claim 2, wherein the user interacts with the virtual object using touch interactions, in the near-field region, by touching the virtual object with a hand of the user in the artificial reality environment, and the user interacts with the virtual object using ray projection interactions, in the far-field region, using a ray that extends from the user's body in the artificial reality environment.

4. The method of claim 1, wherein the engagement gesture comprises a pinch gesture that targets the virtual object.

5. The method of claim 1, wherein the far-field region comprises: a) a radial distance greater than 1 meter from the user; b) a radial distance from the user that meets a convergence criteria for an artificial reality system that implements the artificial reality environment; or c) any combination thereof.

6. The method of claim 5, wherein, when the virtual object is transitioned from the near-field region to the far-field region, the virtual object is pinned to a location at the far-field region that intersects with a ray extended from the user's body.

7. The method of claim 5, wherein when the virtual object is transitioned from the near-field region to the far-field region, the virtual object is scaled up in size.

8. The method of claim 1, wherein the near-field region comprises a three-dimensional free-form space that is configured such that user interactions with the virtual object position the virtual object at different locations within the three-dimensional free-form space.

9. The method of claim 1, wherein the trigger criteria comprises the threshold radial distance, and the threshold radial distance comprises an estimate of the user's arm reach at full extension.

10. A computer-readable storage medium storing instructions that, when executed by a computing system, cause the computing system to trigger object transitions between near-field and far-field regions in an artificial reality environment, the process comprising:
displaying, to a user within an artificial reality environment, a virtual object comprising at least a two-dimensional surface, wherein the virtual object is displayed in a near-field region that is within arm's length from the user;
detecting an engagement gesture, by the user, that engages the virtual object in the near-field region until a release of the engagement by the user;
detecting, after the virtual object is engaged, a hand movement by the user that meets a trigger criteria, wherein the trigger criteria comprises: a) a threshold radial distance from the user; b) a velocity threshold; c) a change in velocity threshold; or d) any combination thereof; and
transitioning, based on the detected hand movement that meets the trigger criteria, the virtual object from the near-field region to a far-field region, wherein the virtual object is displayed in the far-field region at a distance greater than arm's length from the user.

11. The computer-readable storage medium of claim 10, wherein, when displayed in the near-field region the user interacts with the virtual object in the artificial reality environment using touch interactions, and when displayed in the far-field region the user interacts with the virtual object in the artificial reality environment using ray projection interactions.

12. The computer-readable storage medium of claim 11, wherein the user interacts with the virtual object using touch interactions, in the near-field region, by touching the virtual object with a hand of the user in the artificial reality environment, and the user interacts with the virtual object, in the far-field region, using ray projection interactions using a ray that extends from the user's body in the artificial reality environment.

13. The computer-readable storage medium of claim 10, wherein the engagement gesture comprises a pinch gesture that targets the virtual object.

14. The computer-readable storage medium of claim 10, wherein the far-field region comprises: a) a radial distance greater than 1 meter from the user; b) a radial distance from the user that meets a convergence criteria for an artificial reality system that implements the artificial reality environment; or c) any combination thereof.

15. The computer-readable storage medium of claim 14, wherein, when the display of the virtual object is transitioned from the near-field region to the far-field region, the virtual object is pinned to a location at the far-field region that intersects with a ray extended from the user's body.

16. The computer-readable storage medium of claim 14, wherein when the virtual object is transitioned from the near-field region to the far-field region, the virtual object is scaled up in size.

17. The computer-readable storage medium of claim 10, wherein the near-field region comprises a three-dimensional free-form space that is configured such that user interactions with the virtual object position the virtual object at different locations within the three-dimensional free-form space.

18. The computer-readable storage medium of claim 10, wherein the trigger criteria comprises the threshold radial distance, and the threshold radial distance comprises an estimate of the user's arm reach at full extension.

19. A computing system for triggering object transitions between near-field and far-field regions in an artificial reality environment, the computing system comprising:
one or more processors; and
one or more memories storing instructions that, when executed by the one or more processors, cause the computing system to perform a process comprising:
displaying, to a user within an artificial reality environment, a virtual object comprising at least a two-dimensional surface, wherein the virtual object is displayed in a near-field region that is within arm's length from the user;
detecting an engagement gesture, by the user, that engages the virtual object in the near-field region until a release of the engagement by the user;
detecting, after the virtual object is engaged, a hand movement by the user that meets a trigger criteria, wherein the trigger criteria is met when the hand movement: a) extends past a threshold radial distance from the user; b) meets or exceeds a velocity threshold; c) meets or exceeds a change in velocity threshold; or d) any combination thereof; and
transitioning, based on the detected hand movement that meets the trigger criteria, the virtual object from the near-field region to a far-field region, wherein the virtual object is displayed in the far-field region at a distance greater than arm's length from the user.

20. The computing system of claim 19, wherein, when displayed in the near-field region the user interacts with the virtual object in the artificial reality environment using touch interactions, and when displayed in the far-field region the user interacts with the virtual object in the artificial reality environment using ray projection interactions.
